(19) United States
(12) Patent Application Publication
(10) Pub. No.: US 2006/0140649 A1
(43) Pub. Date: Jun. 29, 2006

(54) Image forming apparatus

(76) Inventor: Takao Ichihashi, Osaka (JP)

Correspondence Address: DITTHAVONG & CARLSON, P.C., Suite A, 10507 Braddock Road, Fairfax, VA, 22032, US

(21) Appl. No.: 11/318,691

(22) Filed: Dec. 27, 2005

(30) Foreign Application Priority Data
Dec. 27, 2004 (JP) JP2004-377429

(51) Int. Cl. G03G 15/00

(52) U.S. Cl. 399/17

(57) ABSTRACT

Upon restart of a job after the image forming apparatus is restored from document jam, a message that “If it is possible that the document might be damaged if fed by the document feeder, please press an escape key. If it is not possible that the document might be damaged even fed by the document feeder, please return a pack of documents to the original position” is displayed on a liquid display unit. A user checks the documents discharged and judges whether or not there is a possibility that the document might be damaged. When the user determines that there is a possibility that the document might be damaged, the user presses the “escape key”, and when the user determines that there is no possibility that the document might be damaged, the user presses a restart key.

### BACKGROUND OF THE INVENTION

1. Field of the Invention

The present invention relates to an image forming apparatus, and in particular, the present invention relates to an image forming apparatus contemplating the processing after jam.

2. Description of the Related Art

An image forming apparatus contemplating the processing after jam is disclosed in Japanese Unexamined Patent Publication No. 2001-136339, for example.

According to this publication, when the operation of the image forming apparatus is interrupted due to an occurrence of a recording paper jam while a document is read, a document feeding unit stops the feeding operation once the reading of the current document ends. Then, when a recording operation of the image forming apparatus is restarted after restoring from the paper jam, a document image stored in a storage unit which is recorded on the recording paper that caused the jam, and a document image stored in the storage unit which has been read when the jam is caused are read out to be recorded on the recording paper. On the other hand, documents remaining on a document mounting portion of the document feeder are continuously fed to a document reading unit and the remaining documents are read and a document image is recorded on the recording paper. Thus, an image forming apparatus capable of preventing the damage of the documents is provided, based on the fact that it is not necessary to repeatedly feed the document even if the jam is generated on the recording paper.

The conventional image forming apparatus contemplating the processing of jam was configured as described above. According to Japanese Unexamined Patent Publication No. 2001-136339, it is possible to suppress the damage of the document, since the document read once is not read again (mere feeding of the document to the reading position is not performed). However, after restoring from jam, the documents remaining on the document mounting portion of the document feeder are continuously fed and this involves a problem such that there is a possibility that the document fed again may cause jam.

### SUMMARY OF THE INVENTION

The present invention has been made taking the foregoing problems into consideration and the object of the present invention is to provide an image forming apparatus capable of certainly avoiding jam of a document when reading of the document is restarted after restoring from the jam.

The image forming apparatus according to the present invention comprises a document feeder which feeds a document to a predetermined document reading position; a reading unit which reads the document either at the predetermined document reading position or on a document mounting table; a jam detecting unit which detects jam of the document during feeding of the document in the document feeder; and a control unit, which controls the reading unit so that reading of the document after jam of the document is detected by the jam detecting unit can be performed on the document mounting table.

In this invention, since reading of the document after jam can be performed on the document mounting table, if it is possible that the document may be damaged by feeding the document with a document feeder as it is, reading of the document can be performed by using the document mounting table.

As a result, it is possible to provide an image forming apparatus capable of certainly avoiding jam of the document depending on the user's choice when reading of the document is restarted after restoring from the jam.

Preferably, the image forming apparatus further includes a display unit and the control unit controls the display unit in a manner that display a message is displayed to inquire on which of the document mounting table or the automatic document feeder, the reading of the document reading unit is performed.

According to the other aspect of this invention, the image forming apparatus according to the present invention may include a reading unit, which reads a document either at a predetermined document reading position or on a document mounting table; a paper feeding unit which feeds the paper on which the image of the document is formed to a predetermine image forming position; a paper jam detecting unit, which detects the jam of the paper during feeding of the paper by the paper feeding unit; and a control unit, which controls the reading unit so that reading of the document after jam of the document is detected by the jam detecting unit can be performed on the document mounting table.

### BRIEF DESCRIPTION OF THE DRAWINGS

FIG. 1A is a schematic view showing an entire constitution of an image forming apparatus;

FIG. 1B is a view taken along the arrows IB-IB in FIG. 1A;

FIG. 2 is a functional block diagram of the image forming apparatus; and

FIG. 3 is a flowchart showing an operation of the image forming apparatus.

### DETAILED DESCRIPTION OF THE INVENTION

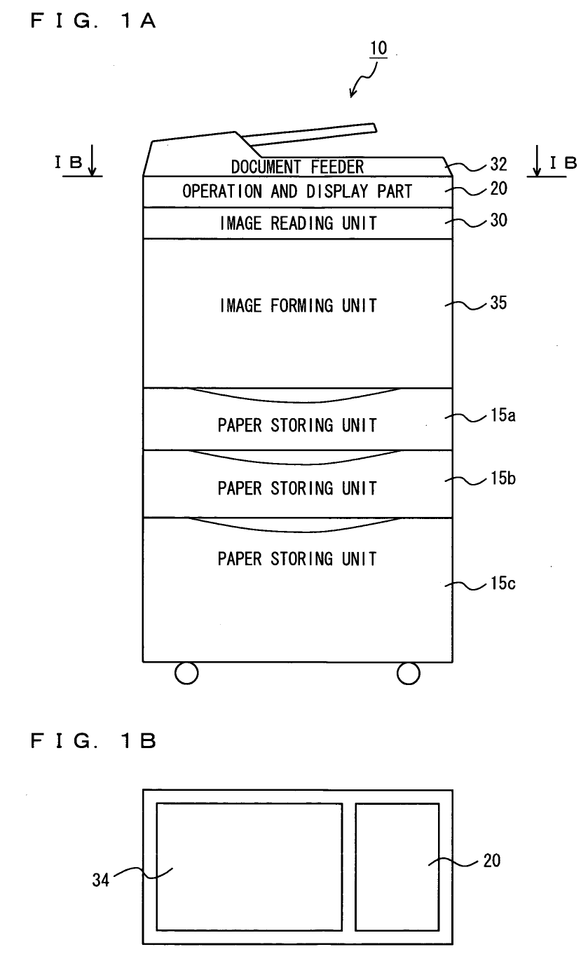

An embodiment of the present invention will be described with reference to the drawings hereinafter. FIG. 1A is a schematic view showing a constitution of an image forming apparatus 10 when an embodiment of the present invention is applied to an image forming apparatus having a copying function. FIG. 1B is a plan view taken along arrows IB-IB in FIG. 1A. Referring to FIG. 1A, the image forming apparatus 10 comprises a document feeder 32 which automatically feeds a document to a predetermined document reading position, an operation and display part 20 serving as an interface between the image forming apparatus 10 and a user, an image reading unit 30 which reads and scans an image of the document transported by the document feeder 32 at the predetermined document reading position, an image forming unit 35 which is provided under the image reading unit 30 and forms the image of the document read by the image reading unit 30, and a plurality of paper storing units 15a to 15c which are provided under the image forming unit 35 and store sheets to be used for copying and the like.

The document feeder 32 can be closed or opened against the operation and display part 20, and FIG. 1B shows a plan view when the document feeder 32 is open. Referring to FIG. 1B, when the document feeder 32 is opened, there are provided a document mounting table 34 on which the document is set with its reading surface down and the operation and display part 20.

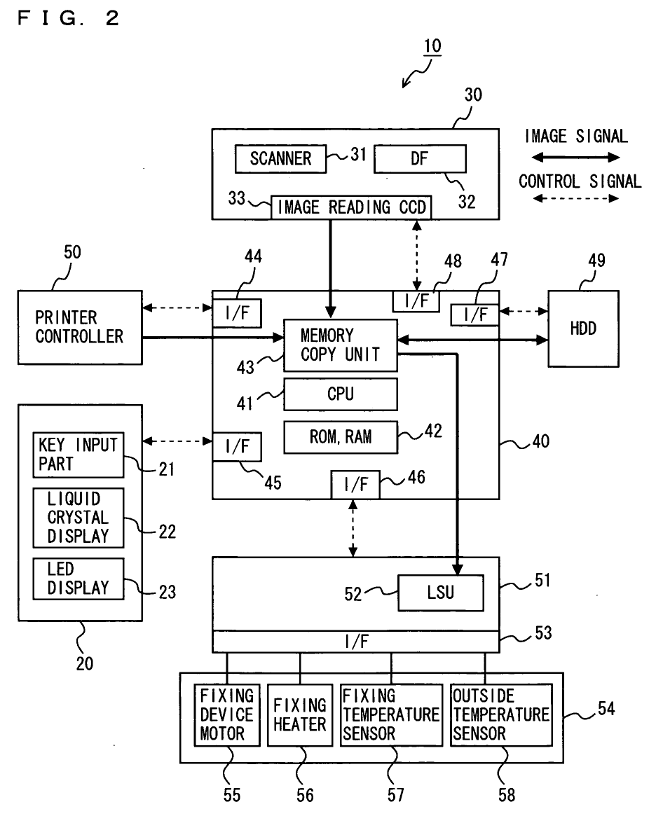

The document set on the document mounting table 34 is read by a scanner 31 having an image reading CCD 33 (refer to FIG. 2).

FIG. 2 is a functional block diagram of the image forming apparatus 10 shown in FIG. 1. In FIG. 2, the same parts as FIG. 1 are given the same reference numerals.

With reference to FIG. 2, the image reading unit 30 of the image forming apparatus 10 includes a scanner 31 for scanning the document and an image reading CCD 33 provided to the scanner. Here, the image reading unit 30 also includes the document feeder 32, which automatically feeds the document to a predetermined document reading position of the scanner 31.

A control unit 40 for controlling the image reading unit 30 and the image forming unit 35 or the like may function as a jam detecting unit and the control unit 40 includes a CPU 41 for controlling the entire image forming apparatus 10, ROM and RAM 42 for storing various data, a memory copy unit 43 for receiving the reading data from the image reading CCD 33 and supplies the data to a hard disk 49 and a printer engine 51, and interfaces (I/F) 44 to 47 with various external devices.

To the interfaces (I/F) 44 to 47, a printer controller 50, the operation and display unit 20, the printer engine 51, the hard disk 49 serving as an image storing unit, and the image reading CCD 33 are connected respectively.

The operation and display unit 20 may include a key input unit 21 such as a numeric keypad, a liquid crystal display unit 22, and an LED display unit 23. The user may set desired copy functions or the like by using the key input unit 21. On the other hand, the CPU 41 may notify the state of the image forming apparatus such as jam by using the liquid crystal display unit 22 and the LED display unit 23. In the meantime, the user can set the desired function of the image forming apparatus through a touch panel by using the liquid crystal display unit 22 as the touch panel.

Further, the key input unit 21 may include “a start button” that starts the operation of reading the document set on the document feeder 32 or the document set on the document mounting table by the user by using the scanner 31 and an “end key” or the like that terminates the end of the reading or the like.

The printer engine 51 may include an LSU (Laser Scanner Unit) 52 and an interface 53 with a fixing device 54, and the fixing device 54 may include a fixing drive motor 55, a fixing heater 56, a fixing temperature sensor 57, and a sensor for sensing a temperature outside the apparatus 58.

On the basis of the setting of the user inputted by the operation and display unit 20, the document is read by the image reading unit 30. The image data of the read document is stored in the RAM 42 and the hard disk 49, and this image data is made into the latent image on a photo conductor dram (not illustrated) incorporated in the printer engine 51 to be transferred to the paper fed from the paper storing units 15a to 15c and fixed by the fixing device 54. Then the paper with the image data is discharged to a paper discharging unit (not illustrated).

In the drawings, a bold line represents flow of an image signal and a thin line represents flow of a control signal.

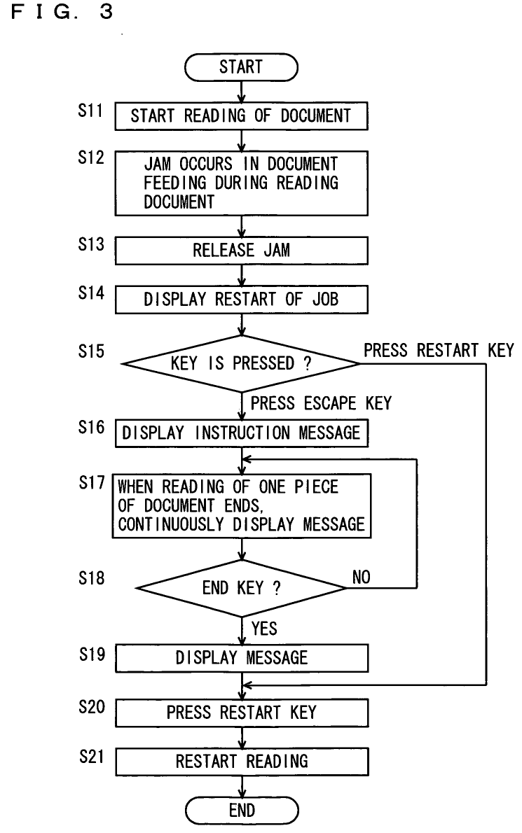

Next, the operation of this image forming apparatus 10 will be described below. FIG. 3 is a flow chart showing the operation in the case of reading the document in the image forming apparatus 10.

With reference to FIG. 3, the user sets the document on the document feeder 32 of the image reading unit 30 and instructs the start of reading the document from the operation and display unit 20 (step S11, hereinafter, the word of step is omitted). If the document is jammed in the document feeder 32 during reading of the document, the CPU 41 detects it, displays a position where the document is jammed on the liquid crystal display unit 22 or the like, and urges the user to discharge the jammed document. In order to check if there is a document that may cause jam again among the documents or not, the user may pick up the all documents set on the document feeder 32.

When the user discharges the jammed document and the CPU 41 confirms it, the image forming apparatus is restored from the jam condition (S13) and a display indicating that the job is allowed to be restarted is displayed on the liquid crystal display unit 22 (S14). In this time, on the liquid crystal display unit 22, the message that “If there is a possibility that the document might be damaged, please press the escape key. If there is no possibility that the document might be damaged, please return a pack of documents to the original position” is displayed, and an “escape key” and a “restart key” are displayed.

Checking the document, the user may determine whether or not it is possible to damage the document during reading in the document feeder 32.

If the user determines that there is a possibility that the document might be damaged, the user may press the “escape key” (press the escape key in S15). Then, the message that “please set the document failed to be read on the document mounting table, and start reading” is displayed on the liquid crystal display unit 22 (S16). If reading of one piece of document ends, the message that “when continuously reading, please replace the document and start reading. When reading ends, please press the end key” is continuously displayed (S17).

If the user determines that there is no possibility that the other documents might not be damaged and the “end key” is pressed (YES in S18), the message that “please set remaining documents on the document feeder 32, and press the restart key” is displayed (S19).

If the user sets the document on the document feeder 32 and presses down the restart key (S20), the reading of the document from the document feeder 32 will be restarted as usual.

When the end key is not pressed down in S18, the processing returns to S17.

On the other hand, when the user sets the remaining documents on the document feeder 32 and presses down the restart key as it is in S15, the processing goes to S20, the normal reading of the document will be restarted.

As described above, according to the present embodiment, since the user checks the document upon restart of reading of the document after restoring from the jam and user can select reading of the document on the document mounting table depending on the state of the document, it is possible to avoid possible document jam due to restart of reading of the document like the conventional case.

In addition, since only the document which might be damaged is read on the document mounting table and the document not in danger of damage can be read by using the document feeder depending on the determination of the user, it is possible to provide the image forming apparatus capable of performing the appropriate reading depending on the document after jam.

According to the above-described embodiment, the case that the document can be read on the document mounting table when the document is jammed is described, however, the present invention is not limited to this, and the same processing is available when the jam is detected by the jam detecting unit during feeding of the paper in the paper feeding unit for feeding the paper on which the image of the document is formed from paper storing units to the predetermine image forming position.

Although the embodiments of the present invention have been described with reference to the drawings in the above, the present invention is not limited to the above-illustrated embodiments. It is possible to add various modifications and variations may be added to the illustrated embodiment in the same or the equivalent scope thereof.

What is claimed is:

1. An image forming apparatus, comprising:
a document feeder feeding a document to a predetermined document reading position;
a reading unit reading the document either at the predetermined document reading position or on a document mounting table;
a jam detecting unit detecting jam of the document while the document feeder feeds the document; and
a control unit controlling the reading unit so that after detecting the jam of the document by the jam detecting unit, reading of the document is performed on the document mounting table.

2. The image forming apparatus according to claim 1, further comprising:
a display unit, wherein the control unit controls the display unit so that a message is displayed to inquire whether the reading of the document is performed at the predetermined document reading position or on the document mounting table.

3. An image forming apparatus, comprising:
a reading unit reading the document either at the predetermined document reading position or on a document mounting table;
a paper feeding unit feeding paper, on which an image of the read document is formed, to a predetermine image forming position;
a paper jam detecting unit detecting jam of the paper while the document paper feeding unit feeds the paper; and
a control unit controlling the reading unit so that after detecting the jam of the paper by the paper jam detecting unit, reading of the document is performed on the document mounting table.
